(19) United States
(12) Patent Application Publication
(10) Pub. No.: US 2021/0090039 A1
(43) Pub. Date: Mar. 25, 2021

(54) INFORMATION PROCESSING APPARATUS

(71) Applicant: FUJI XEROX CO., LTD., Tokyo (JP)

(72) Inventor: Dawei YANG, Kanagawa (JP)

(73) Assignee: FUJI XEROX CO., LTD., Tokyo (JP)

(21) Appl. No.: 16/749,126

(22) Filed: Jan. 22, 2020

(30) Foreign Application Priority Data
Sep. 20, 2019 (JP) 2019-172115

(51) Int. Cl. G06Q 20/08; G06Q 30/04; G06Q 20/28; G06F 21/34; G06F 3/12

(52) U.S. Cl. CPC G06Q 20/0855; G06Q 30/04; G06Q 20/28; G06F 3/1203; G06F 2206/1512; G06F 3/1273; G06F 21/34

(57) ABSTRACT

An information processing apparatus includes an acquisition unit that acquires an image used in paid image processing and an output unit that outputs settlement information for use in settlement of a fee for the image processing if the image satisfies a settlement condition indicating whether the fee is a settlement target.

### CROSS-REFERENCE TO RELATED APPLICATIONS

This application is based on and claims priority under 35 USC 119 from Japanese Patent Application No. 2019-172115 filed Sep. 20, 2019.

### BACKGROUND

### (i) Technical Field

The present disclosure relates to an information processing apparatus.

### (ii) Related Art

Japanese Unexamined Patent Application Publication No. 2010-136141 discloses a document output technique. According to the disclosed technique, the probability of use of text data as a document is calculated with the text data included in document data specified to be output. The document is output by using a device control code registered in a document purpose selected in accordance with the calculated probability and by using a print format setting value.

When paid image processing services, such as copying or fax, are used, they may be used for personal purpose or business purpose. Since typical receipt does not include information that differentiates usage purposes, it is difficult to settle an advance payment that may be related to business.

### SUMMARY

Aspects of non-limiting embodiments of the present disclosure relate to settling more easily a fee for paid image processing service than when a typical receipt having no information clarifying usage purposes is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. An information processing apparatus includes an acquisition unit that acquires an image used in paid image processing and an output unit that outputs settlement information for use in settlement of a fee for the image processing if the image satisfies a settlement condition indicating whether the fee is a settlement target.

### BRIEF DESCRIPTION OF THE DRAWINGS

Exemplary embodiments of the present disclosure will be described in detail based on the following figures, wherein:

FIG. 1 illustrates a hardware configuration of an image processing apparatus of an exemplary embodiment;

FIG. 2 illustrates a hardware configuration of a server apparatus;

FIG. 3 illustrates a hardware configuration of an image processing apparatus;

FIG. 4 illustrates a hardware configuration of a business terminal;

FIG. 5 illustrates a functional configuration of a settlement assisting system;

FIG. 6 illustrates an example of usage information;

FIG. 7 illustrates an example of a feature table;

FIG. 8 illustrates an example of determination process of usage purpose;

FIG. 9 illustrates an example of relevant information;

FIG. 10 illustrates an example of receipt information;

FIG. 11 illustrates an example of advance payment information displayed;

FIG. 12 illustrates an example of a receipt output process;

FIG. 13 illustrates an example of an advance payment information output process;

FIG. 14 illustrates an example of a settlement condition of a modification of the exemplary embodiment;

FIG. 15 illustrates an example of the settlement condition of the modification;

FIG. 16 illustrates an example of the settlement condition of the modification; and

FIG. 17 illustrates an example of receipt information of the modification.

### DETAILED DESCRIPTION

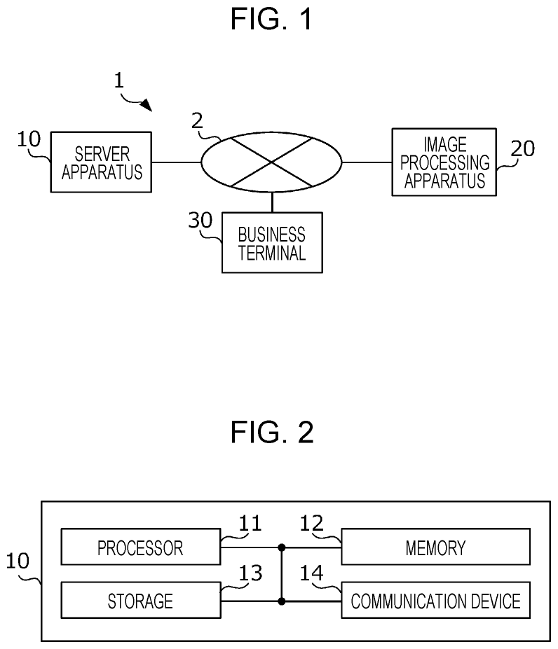

FIG. 1 illustrates a whole configuration of a settlement assisting system 1 of an exemplary embodiment. The settlement assisting system 1 assists in a settlement job of a fee (advance amount) which a member of a corporation (employee) has paid in advance payment. In accordance with the exemplary embodiment, the settlement assisting system 1 assists in the settlement job for the fee paid by the employee. The settlement assisting system 1 includes a communication network 2, server apparatus 10, image processing apparatus 20, and business terminal 30.

The communication network 2 is a communication system including a mobile communication network and the Internet and relays data communication among apparatuses (including terminals and systems) that communicate with the communication network 2. The communication network 2 is wiredly connected to the server apparatus 10, image processing apparatus 20, and business terminal 30. The communication between each apparatus and the communication network 2 may be wireless or wired communication.

The image processing apparatus 20 provides a user (for example, a member of the corporation) with paid services for image processing, such as printing, copying, scanning, and/or faxing of image data (hereinafter referred to as “image processing service”). The server apparatus 10 performs a process to assist in the settlement of fees for the image processing services and is an example of an information processing apparatus of the disclosure. The business terminal 30 is used by a person in charge of the settlement job in the corporation. The business terminal 30 is used for the verification and confirmation of settlement amount.

FIG. 2 illustrates the hardware configuration of the server apparatus 10. The server apparatus 10 is a computer and includes a processor 11, memory 12, storage 13, and communication device 14. The processor 11 includes an arithmetic unit, such as a central processing unit (CPU), register, and peripheral circuit. The memory 12 is a recording medium readable by the processor 11 and includes a random-access memory (RAM) and read-only memory (ROM).

The storage 13 is a recording medium readable by the processor 11 and, for example, includes a hard disk drive or a flash memory. The processor 11 controls operation of each hardware element by using the RAM as a working area and by executing a program stored on the ROM or the storage 13. The communication device 14 is a communication medium performing communication via the communication network 2 and includes an antenna and a communication circuit.

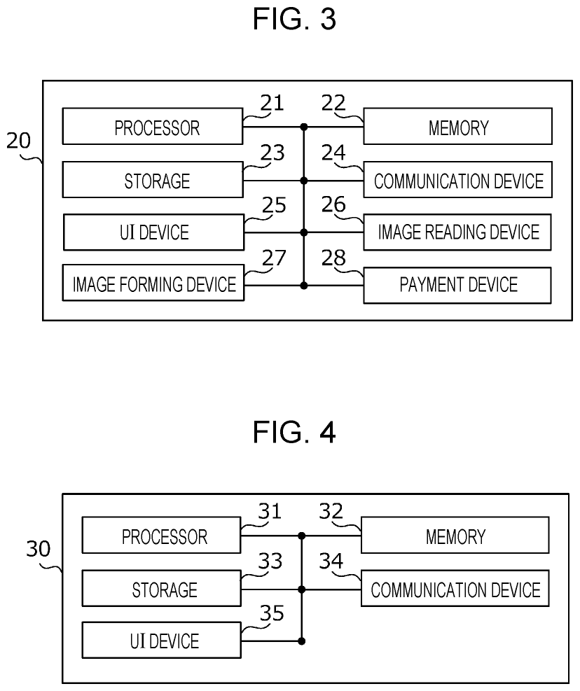

FIG. 3 illustrates the hardware configuration of the image processing apparatus 20. The image processing apparatus 20 is a computer and includes a processor 21, memory 22, storage 23, communication device 24, user interface (UI) device 25, image reading device 26, image forming device 27, and payment device 28. The processor 21, memory 22, storage 23, and communication device 24 are respectively identical to the processor 11, memory 12, storage 13, and communication device 14 in FIG. 2 in terms of hardware point of view.

The UI device 25 is an interface provided to a user who uses the image processing apparatus 20. For example, the UI device 25 includes a display and a touch screen having a touch panel arranged on the top face of the display. The UI device 25 displays a screen while receiving an operation from the user. The UI device 25 also includes an operator, such as a keyboard, in addition to the touch screen and receives an operation performed on the operator.

The image reading device 26 is hardware (for example, a scanner) reading an image on a medium, such as a paper sheet, and is an image reading unit that reads an image from the medium set thereon. The image forming device 27 is a printer forming an image on a medium, such as a paper sheet and is thus an image forming unit. The image forming device 27 transfers an image to a medium in an electrophotographic system while transporting the medium set thereon and thus forms the image on the medium. The payment device 28 collects a fee the user has paid for the paid image processing service provided by the image processing apparatus 20.

FIG. 4 illustrates the hardware configuration of the business terminal 30. The business terminal 30 is a computer and includes a processor 31, memory 32, storage 33, communication device 34, and UI device 35. The processor 31, memory 32, storage 33, communication device 34, and UI device 35 are respectively identical to the processor 21, memory 22, storage 23, communication device 24, and UI device 25 in FIG. 3 in terms of hardware point of view.

The settlement assisting system 1 implements functions described below when the processor in each apparatus executes the program thereof and thus controls elements in each apparatus. The operation of each function is described as an operation performed by the processor in each apparatus that implements the function.

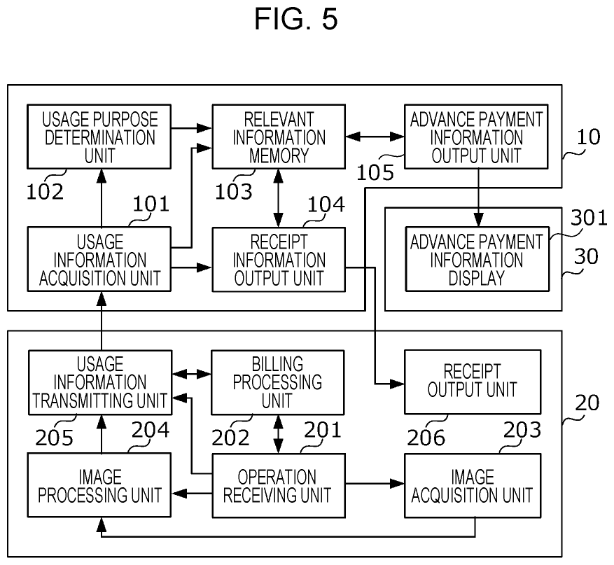

FIG. 5 illustrates the functional configuration of the settlement assisting system 1. The server apparatus 10 includes a usage information acquisition unit 101, usage purpose determination unit 102, relevant information memory 103, receipt information output unit 104, and advance payment information output unit 105. The image processing apparatus 20 includes an operation receiving unit 201, billing processing unit 202, image acquisition unit 203, image processing unit 204, usage information transmitting unit 205, and receipt output unit 206. The business terminal 30 includes an advance payment information display 301.

When the user of the image processing apparatus 20 uses a paid image processing service, the operation receiving unit 201 receives an operation. For example, the operation receiving unit 201 displays a usage start button to start using the image processing service on the display of the image processing apparatus 20. When the usage start button is operated, the operation receiving unit 201 causes the display to display a list of image processing services and receives an operation to select an image processing service to be used.

The operation receiving unit 201 displays a setting screen responsive to the selected image processing service and receives an operation for a setting from the user. The setting includes the type of medium forming an image, the size of medium, the number of media, the selection of color mode, the selection of resolution of the image, the designate of a storage destination of the image, and/or the designate of a fax transmission destination. When the operation for the setting is received, the operation receiving unit 201 notifies the billing processing unit 202 of the contents of the setting.

The billing processing unit 202 performs a process related to billing when the image processing service having the set contents is performed on the image processing apparatus 20. The billing processing unit 202 calculates the fee when the image processing service having the set contents notified is used and displays the calculated fee on the display. When the user has paid an amount to the payment device 28, the billing processing unit 202 calculates the paid amount. If the calculated amount reaches the calculated fee, the billing processing unit 202 notifies the operation receiving unit 201 that the fee for the use of the image processing service has been paid.

When the notification is received, the operation receiving unit 201 displays a process start button to start an imaging process for the image processing service. When the user operates the process start button, the operation receiving unit 201 supplies the setting contents to the image acquisition unit 203 and image processing unit 204. The image acquisition unit 203 acquires an image for use in the image processing service (namely, an image to be processed) on the image processing apparatus 20. If the image processing service used is copying, scanning, or faxing, the image acquisition unit 203 performs a process to transport a medium set on the image processing apparatus 20 and to cause the image reading device 26 to read the medium.

If the image processing service to be used is printing, the image acquisition unit 203 performs a process to retrieve an image from a storage location where the image is stored. The image acquisition unit 203 retrieves images on a per document basis with each document including at least one image. The document may include a proposal, specifications, operation manual, contracts used in a corporation and may further include tickets used by individuals and reservation status of the tickets. The image acquisition unit 203 supplies the acquired image to the image processing unit 204.

The image processing unit 204 performs on the supplied image a process responsive to the image processing service to be used. If the image processing service used is printing or copying, the image forming device 27 forms an image on a medium. If the image processing service used is scanning, the image processing unit 204 stores an image at a set storage location. If the image processing service to be used is faxing, the image processing unit 204 transmits an image to a set destination.

The image processing unit 204 supplies to the usage information transmitting unit 205 setting information indicating the setting used in the image processing service and the processed image. If the image processing service used by the user includes a service for business purpose, a receipt for proving the payment for the fee is to be used. The operation receiving unit 201 causes to be displayed a receipt issue button that is used to complete the use of the image processing apparatus 20 and issue a receipt.

When the user operates the receipt issue button, the operation receiving unit 201 notifies the usage information transmitting unit 205 of usage start time when the usage start button is operated and usage end time when the receipt issue button is operated. The usage information transmitting unit 205 generates usage information related to the use of the image processing service by the user and transmits to the server apparatus 10 request data indicating the generated usage information and a request for receipt information indicative of the contents of a receipt for a usage fee.

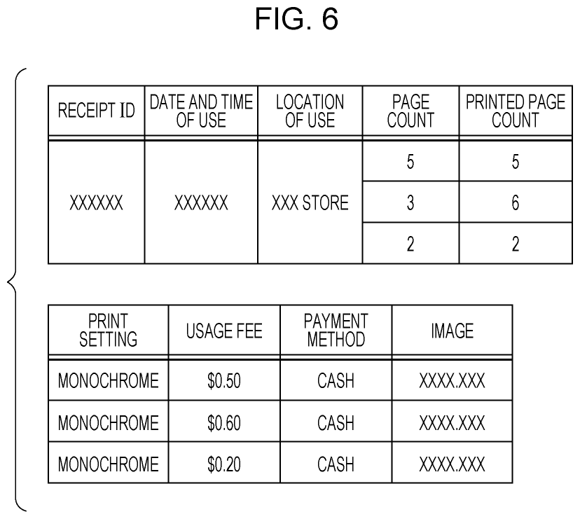

FIG. 6 illustrates an example of the usage information. Referring to FIG. 6, the usage information transmitting unit 205 generates the usage information when the image processing service for printing or copying is used. The usage information includes receipt identification (ID), date and time of use, location of use, page count of an image, printed page count, print setting, usage fee, payment method, and the image (as a file name in FIG. 6) in association with each other. Referring to FIG. 6, a store name is displayed as the location of use. The usage information may include as the location of use a store name, location of the store, and phone number of the store.

The usage information transmitting unit 205 issues and assigns a receipt ID for an image processing service used between the usage start time and the usage end time. For example, the usage information transmitting unit 205 includes, in the usage information, the usage start time as the usage date and time and the store memorized in advance and having the image processing apparatus 20 installed as the location of use. The usage information transmitting unit 205 asks the billing processing unit 202 about a usage fee and payment method (only “cash” in the exemplary embodiment) for each image processing service and then includes the usage fee and payment method in the usage information.

The usage information transmitting unit 205 includes image data supplied from the image processing unit 204 into the usage information. The usage information transmitting unit 205 transmits to the server apparatus 10 the request data indicating the generated usage information illustrated in FIG. 6. The usage information acquisition unit 101 in the server apparatus 10 acquires the usage information indicated by the request data transmitted. The acquired usage information includes an image used in the image processing. The usage information acquisition unit 101 is an example of an acquisition unit of the disclosure.

The usage information acquisition unit 101 supplies the acquired usage information to the usage purpose determination unit 102 and relevant information memory 103. The usage purpose determination unit 102 determines the usage purpose of the image processing service used by the user in accordance with the acquired usage information. The usage purpose is largely divided into corporative use and unincorporated use. The corporative use means that the image processing service is used for corporate business to which the user belongs to. For example, the corporate use includes printing of a proposal or quotation, printing of corporate internal materials, and fax transmission for order confirmation.

The unincorporated use means that the image processing service is used for purposes other than the corporate use, namely, the user□s own purpose. For example, the unincorporated use includes printing of a purchased recipe or musical score, printing of a ticket, fax transmission to a reserve destination. The usage purpose determination unit 102 analyzes the image included in the acquired usage information, namely, the image of a document (hereinafter referred to as a “usage image”) which is used when the user uses the image processing service. The usage purpose determination unit 102 then determines the usage purpose.

The usage purpose determination unit 102 identifies the type of the document in accordance with the feature of the image and determines the usage purpose in accordance with the identified type of the document. The usage purpose determination unit 102 stores a feature table that associates the type of the document with the feature of the image.

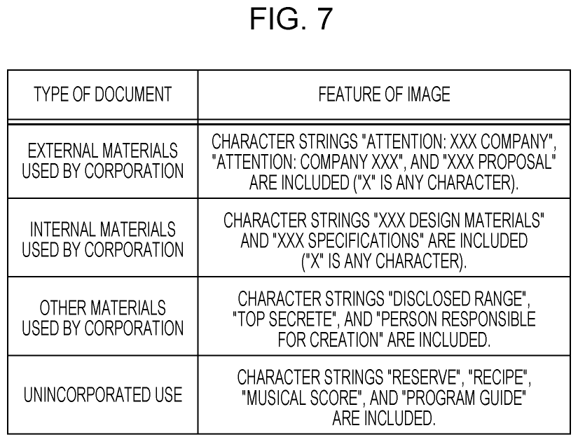

FIG. 7 illustrates an example of the feature table. Referring to FIG. 7, the type of the document “external materials used by corporation” is associated with the feature of the image “Character strings □Attention: xxx company□, □Attention: company xxx□, and □xxx proposal□ are included (□x□ is any character)”.

The type of the document “Internal materials used by corporation” is associated with the feature of the image “Character strings □xxx design materials and □xxx specifications are included (□x□ is any character)” The type of the document “Other materials used by corporation” is associated with the feature of the image “Character strings □disclosed range□, □top secret□, and □person responsible for creation□ are included”. The type of the document “unincorporated use” is associated with the feature of the image “Character strings □reserve□, □recipe□, □musical score□, and □program guide□ are included”.

The character strings in FIG. 7 are typically used in the corresponding type of documents while not being used in the other type of documents. FIG. 7 illustrates the character strings for exemplary purposes. Additional words or substitute words may be used as long as these words are typically used in the corresponding type of document while not being used in the other type of document. The usage purpose determination unit 102 recognizes a character string from the usage image via character recognizing technique of optical character recognition (OCR).

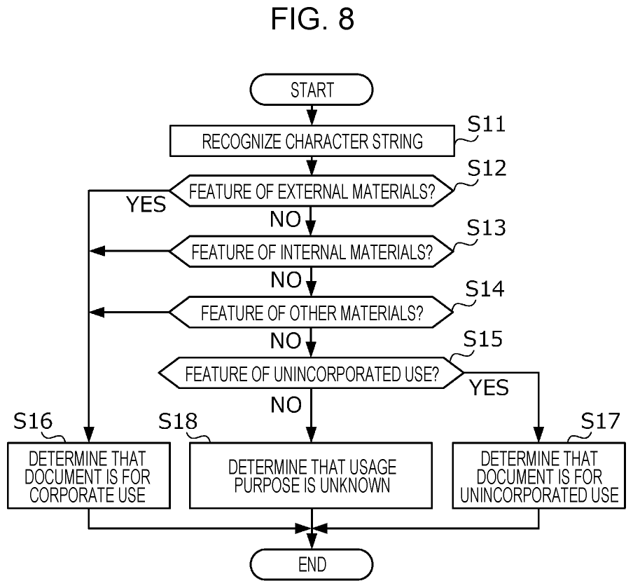

Depending on whether a recognized character string matches a character string listed in the feature table, the usage purpose determination unit 102 determines the usage purpose. The determination process of the usage purpose is described with reference to the flowchart in FIG. 8. FIG. 8 illustrates the flowchart of the usage purpose determination process. The usage purpose determination process in FIG. 8 is performed on each usage image (namely, on each document) included in the usage information.

The usage purpose determination unit 102 recognizes a character string from the usage image (step S11). The usage purpose determination unit 102 determines whether the recognized character string includes a character string associated with “external materials used by corporation” in the feature table, namely, determines whether the recognized character string has the feature of “external materials used by corporation” (step S12). If the usage purpose determination unit 102 determines in step S12 that the recognized character string has the feature (yes path from step S12), the usage purpose determination unit 102 determines that the usage image as a determination target is the image of a document for corporate use (step S16) and ends the usage purpose determination process.

If the usage purpose determination unit 102 determines in step S12 that the image does not have the feature (no path from step S12), the usage purpose determination unit 102 determines whether the recognized character includes a character string corresponding to “internal materials used by corporation” in the feature table, namely, determines whether the recognized character string has the feature of the internal materials used by corporation (step S13). If the usage purpose determination unit 102 determines in step S13 that the recognized character string has the feature (yes path from step S13), the usage purpose determination unit 102 determines that the usage image as a determination target is an image of the document for the corporate use (step S16) and ends the usage purpose determination process.

If the usage purpose determination unit 102 determines in step S13 that the recognized character string does not have the feature (no path from step S13), the usage purpose determination unit 102 determines whether the recognized character string includes a character string associated with “other materials used by corporation” in the feature table, namely, determines whether the recognized character string has the feature of other materials used by corporation (step S14). If the usage purpose determination unit 102 determines in step S14 that the image has the feature (yes path from step S14), the usage purpose determination unit 102 determines that the usage image as a determination target is an image of the document for the corporate use (step S16) and ends the usage purpose determination process.

If the usage purpose determination unit 102 determines in step S14 that the image does not have the feature (no path from step S14), the usage purpose determination unit 102 determines whether the recognized character string includes a character string associated with the unincorporated use in the feature table, namely, determines whether the recognized character string has the feature of the unincorporated use (step S15). If the usage purpose determination unit 102 determines in step S15 that the recognized character string has the feature (yes path from step S15), the usage purpose determination unit 102 determines that the usage image as a determination target is an image of the document for the unincorporated use (step S17) and ends the usage purpose determination process.

If the usage purpose determination unit 102 determines in step S15 that the recognized character string does not have the feature (no path from step S15), the usage purpose determination unit 102 determines that the usage purpose of the usage image as a determination target is unknown (step S18) and ends the usage purpose determination process. The fee paid for the corporate use serves as a settlement target. If the usage image satisfies the settlement condition indicating whether the fee paid for use of the image processing service (the fee paid by the user) is a settlement target, the usage purpose of the usage image is for the corporate use.

The settlement conditions in the exemplary embodiment are the determination conditions used steps S12, S13, and S14 (the conditions as to whether the usage image has the feature of the external materials, the feature of the internal materials, or the feature of the other materials). The usage purpose determination unit 102 identifies the document name in addition to determining the usage purpose as described above. The usage purpose determination unit 102 identifies as a document name a character string at the beginning of the document among the character strings recognized from the usage image. The usage purpose determination unit 102 supplies the determination results of the usage purpose and the identified document name to the relevant information memory 103.

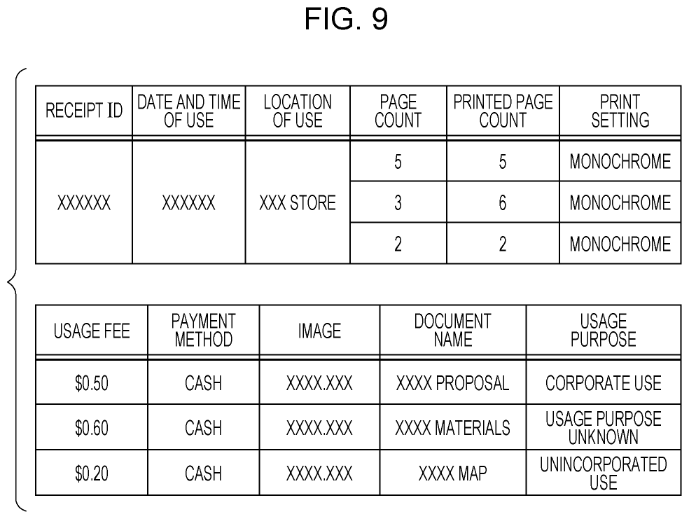

The relevant information memory 103 stores relevant information related to the use of the image processing service provided by the image processing apparatus 20. FIG. 9 illustrates an example of the relevant information. Referring to FIG. 9, the relevant information memory 103 stores as the relevant information the usage information supplied from the usage information acquisition unit 101 and illustrated in FIG. 6 and the document name and usage purpose supplied from the usage purpose determination unit 102.

Upon receiving the request data from the image processing apparatus 20, the usage information acquisition unit 101 notifies the receipt information output unit 104 that the receipt information has been requested. Upon receiving the notification, the receipt information output unit 104 references the relevant information stored on the relevant information memory 103, generates the receipt information indicating the contents of the requested receipt, and outputs the generated receipt information to the image processing apparatus 20 as a requester.

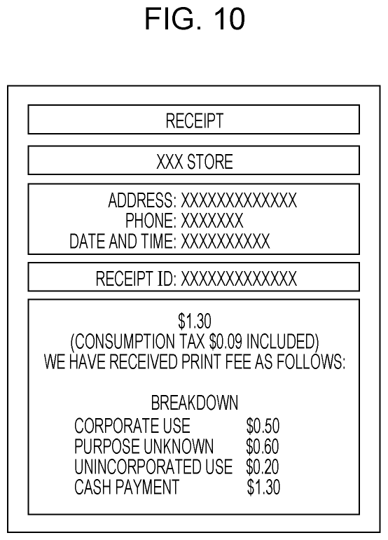

In accordance with the exemplary embodiment, the receipt information output unit 104 generates and outputs the receipt information indicating in image the contents of the receipt. FIG. 10 illustrates an example of the receipt information. Referring to FIG. 10, the receipt information output unit 104 generates the receipt information under the character string “Receipt”. The receipt information includes the name of the store, address, phone number, date and time of use, receipt ID, sum of usage fees, breakdown of the usage fees (the usage purpose and fee for each usage image).

The name of the store, address, phone number, date and time of use, receipt ID, sum of the usage fees, breakdown of the usage fees are included in the relevant information. If the corporate use is included as the usage purpose, the fee for the corporate use serves as a target for settlement. The usage image in the image processing service used for the corporate use thus satisfies the settlement condition.

If the usage image satisfies the settlement condition, the receipt information output unit 104 generates the receipt information, indicating the contents of the receipt for the fee, as the settlement information for use in the settlement of the fee for the image processing service using the usage image and outputs the generated receipt information. The receipt information output unit 104 is an example of an “output unit” of the disclosure. The receipt output unit 206 in the image processing apparatus 20 outputs the receipt indicated by the output receipt information onto a paper medium for the receipt.

The user having used the image processing service uses the output receipt to perform a settlement process to settle an advance payment for business. The user performs the settlement process by performing an operation to input an advance amount on an in-house settlement system and an operation to send the receipt in FIG. 10 to a checkout division. If the receipt in FIG. 10 has been output, an amount $0.50 for the corporate use in the breakdown is basically handled as an unconditional settlement target. For this reason, even if the user does not remember the advance payment, the fee for the corporate use in the breakdown is automatically settled.

If the user remembers that the fee for purpose unknown in the breakdown has been actually the corporate use, he or she simply performs the settlement process for that fee as well. A person in charge of settlement in the checkout division performs the settlement job using the received receipt. Concerning the settlement for a fee for the corporate use in the breakdown, the person in charge is aware that the fee is the unconditional settlement target and performs the settlement process.

The settlement process is performed to add the settled fee to the salary of an employee who has paid the fee in advance and transfer the sum to the employee on the payday (or to transfer the settled amount any time). The settlement job is thus more quickly performed than when the paid amount is checked each time. Concerning the settlement of the fee for “purpose unknown” in the breakdown, the person in charge checks the contents of the payment using the business terminal 30.

The advance payment information display 301 in the business terminal 30 causes a display thereof to display advance payment information related to an advance amount that has undergone the settlement. The advance payment information display 301 causes the display to display a screen that receives an operation for the advance payment. If the person in charge enters a receipt ID and performs an operation to instruct the corresponding advance payment information to be displayed, the advance payment information display 301 transmits to the server apparatus 10 the request data requesting the advance payment information.

The advance payment information output unit 105 in the server apparatus 10 outputs to the business terminal 30 the advance payment information associated with the receipt ID requested by the incoming request data. The advance payment information output unit 105 references the relevant information memory 103, reads the relevant information stored in association with the receipt ID indicated by the request data, and then outputs to the business terminal 30 the read relevant information as the advance payment information.

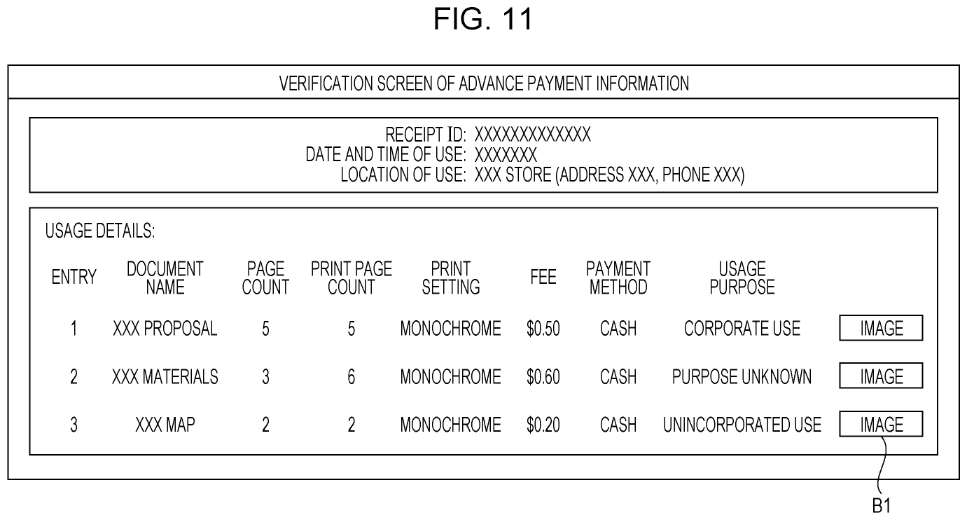

The advance payment information display 301 causes the display to display the output advance payment information. FIG. 11 illustrates an example of the advance payment information displayed. Referring to FIG. 11, the advance payment information display 301 displays in “verification screen of advance payment information” a receipt ID, date and time of use, location of use, and usage details including the document name, page count, printed page count, print setting, fee, payment method, and usage purpose displayed as in FIG. 9.

The advance payment information display 301 displays an image button B1 used to display the image of each document. When the person in charge operates the image button B1 displayed beside the document with “purpose unknown”, the advance payment information display 301 displays the image of the corresponding document. In this way, the receipt information output unit 104 outputs to the business terminal 30 the receipt information including the usage image as the settlement information. The business terminal 30 is a destination to the person in charge of the settlement job for the fees for the image processing service.

The image of the document actually printed via the image processing service for printing used by the user is thus displayed. The person in charge of the settlement job views the displayed image and checks whether the image has been printed for the corporate use, namely, whether the fee for the image processing service is a settlement target.

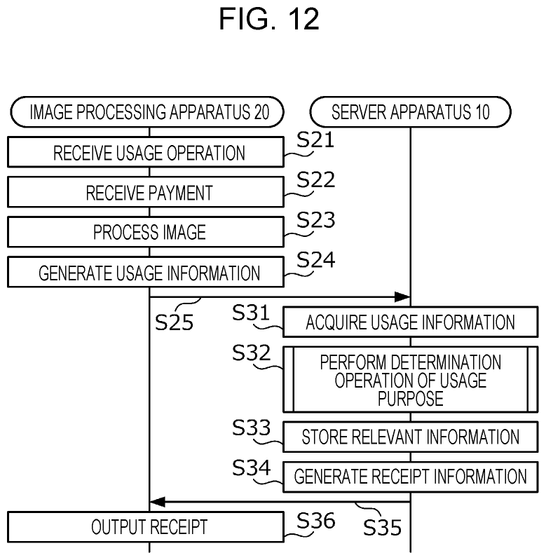

Each apparatus in the settlement assisting system 1 is configured as described and performs a settlement assisting process to assist in the settlement job for the advance payment. The settlement assisting process includes a receipt output operation to output a receipt indicating a usage purpose and an advance payment information output operation to output the advance payment information. FIG. 12 illustrates an example of the receipt output process. The image processing apparatus 20 (the operation receiving unit 201) receives an operation to use the image processing service (step S21).

The image processing apparatus 20 (the billing processing unit 202) receives the payment of the usage fee for the image processing service (step S22). The image processing apparatus 20 (the image acquisition unit 203 and image processing unit 204) processes the image related to the image processing service (for example, an image reading operation and an image forming operation in the image processing service for copying) (step S23). The image processing apparatus 20 (the usage information transmitting unit 205) generates the usage information related to the use of the image processing service by the user (step S24) and transmits the generated usage information to the server apparatus 10 (step S25).

The server apparatus 10 (the usage information acquisition unit 101) acquires the incoming usage information (step S31). The server apparatus 10 (the usage purpose determination unit 102) performs a determination operation to determine the usage purpose as described with reference to FIG. 8 (step S32). The server apparatus 10 (the relevant information memory 103) stores the relevant information including the acquired usage information and the results of the determination operation (step S33).

The server apparatus 10 (the receipt information output unit 104) generates the receipt information in FIG. 10 by referencing the stored relevant information (step S34) and outputs the generated receipt information to the image processing apparatus 20 that has provided the image processing service (step S35). The image processing apparatus 20 (the receipt output unit 206) outputs to the paper medium the receipt represented by the output receipt information (step S36).

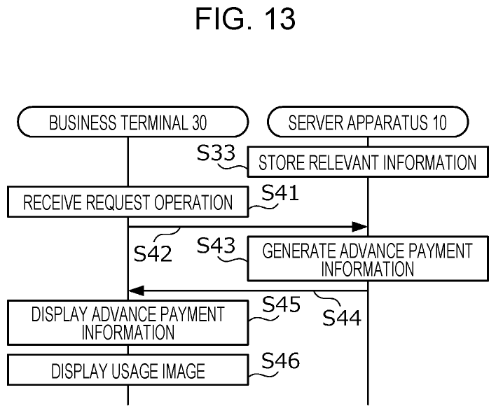

FIG. 13 illustrates an example of an advance payment information output process. The advance payment information output process in FIG. 13 is performed after the server apparatus 10 (the relevant information memory 103) stores the relevant information in step S33 in FIG. 12. The business terminal 30 (the advance payment information display 301) receives an operation requesting the advance payment information by displaying on the display the screen to receive an operation related to an advance amount (step S41). The business terminal 30 then transmits the request data requesting the advance payment information to the server apparatus 10 (step S42).

The server apparatus 10 (the advance payment information output unit 105) generates the advance payment information requested by the incoming request data (step S43) and outputs the generated advance payment information to the business terminal 30 (step S44). The business terminal 30 (the advance payment information display 301) causes the display to display the output advance payment information in FIG. 11 (step S45). If the image button Bl is operated, the business terminal 30 (the advance payment information display 301) causes the display to display the usage image of the corresponding document (step S46).

In accordance with the exemplary embodiment, if the usage image satisfies the settlement condition, the receipt information output unit 104 outputs, as the settlement information to be used to settle the fee for the image processing service using the usage image, the receipt information representing the usage purpose and costs in association with each other in FIG. 10. The fee for the use of paid image processing may thus be more easily settled than when the settlement is performed using a standard receipt having no information discriminating the personal use from the corporate use.

The exemplary embodiment of the disclosure has been described for exemplary purposes only and may be modified as described below. The exemplary embodiment and the modification thereof may be combined as appropriated.

In accordance with the exemplary embodiment, the receipt information output unit 104 outputs, as the receipt information indicating the contents of the receipt, the image indicating the contents of the receipt. Alternatively, the receipt information output unit 104 may output a text indicating the contents of the receipt. The receipt information output unit 104 may output information that is a mixture of the image and text. If the text is output, the receipt output unit 206 in the image processing apparatus 20 may generate an image of a receipt and outputs the image to a medium.

In accordance with the exemplary embodiment, the usage purpose determination unit 102 uses as the settlement condition a condition as to whether a specific character string (one of the character strings in FIG. 7) is included in the usage image. A different condition may be used. The usage purpose determination unit 102 may use a condition as to whether the usage image includes the name of a company, logo of the company, address of the company, office name, phone number, fax number, and/or document format particular to the company. Concerning the logo of the company or the document format, pattern recognition may be used instead of character recognition.

The image processing apparatus 20 may provide the image processing service to a user who has been authenticated. In this modification, identification information (such as user ID) of the user who uses the image processing service in the settlement assisting system 1 is registered beforehand. An authentication server that authenticates the user with registered identification information is arranged.

The operation receiving unit 201 in the image processing apparatus 20 receives identification information (input manually or via near-field communication) and authenticates the user of the image processing service by communicating with the authentication server. The operation receiving unit 201 of the modification is an example of an “authenticating unit”. The authentication method may be any method. The function of authentication may be separately implemented in the server apparatus 10.

The image processing apparatus 20 may provide the image processing service to only the authenticated user or to a user who has not been authenticated. If the image processing service is provided regardless of whether the user is authenticated or not, the usage purpose determination unit 102 may determine the usage purpose by using as the settlement condition a condition that is different from the image processing service with the user authenticated to the image processing service with the user unauthenticated.

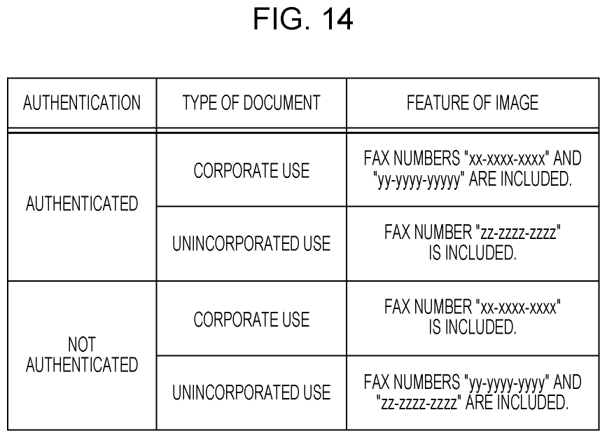

FIG. 14 illustrates an example of a settlement condition of the modification. Referring to FIG. 14, the settlement condition is displayed when the image processing service for faxing is used. Specifically, if the user is authenticated, the settlement condition is that the usage image including a fax number “xx-xxxx-xxxx” or “yy-yyyy-yyyy” is determined to be for the corporate use and the usage image including a fax number “zz-zzzz-zzzz” is determined to be for the unincorporated use.

If the user is authenticated, the settlement condition is that the usage image including the fax number “xx-xxxx-xxxx” is determined to be for the corporate use and the usage image including the fax number “yy-yyyy-yyyy” or “zz-zzzz-zzzz” is determined to be for the unincorporated use. The fee for faxing to the fax number “yy-yyyy-yyyy” serves as a settlement target if the user is authenticated but does not serve as a settlement target if the user is unauthenticated.

The determination is performed as described above. If the usage image satisfies the settlement condition that is different from the image processing service with the user authenticated the image processing service with the user unauthenticated, the receipt information output unit 104 outputs the receipt information as the settlement information for use in settling the fee for the image processing service.

The fax number “yy-yyyy-yyyy” may be a fax number for help desk and may be used for business or personal use. Although the authentication operation is a slightly annoying, it is possible that the authentication operation is still performed for the image processing service for the corporate use while the authentication operation is not performed for the image processing service for personal use.

In comparison of the authenticated case (with the user authenticated) with the unauthenticated case (with the user unauthenticated), the authenticated case is more likely to be for the corporate use. The fee for the image processing service using the fax number “yy-yyyy-yyyy” is set to be a settlement target in the authenticated while the fee is not set to be a settlement target in the unauthenticated case. In comparison with the case in which the settlement condition is fixed regardless of the authenticated case or the unauthenticated case, the accuracy level of the determination as to whether the fee is a settlement target is increased.

If the authentication has been made, is the user are differentiated from one to another. The usage purpose determination unit 102 may determine the usage purpose by using as the settlement condition a condition that is different from the image processing service in the authenticated case to the image processing service in the unauthenticated case and that is also different from authenticated user to authenticated user.

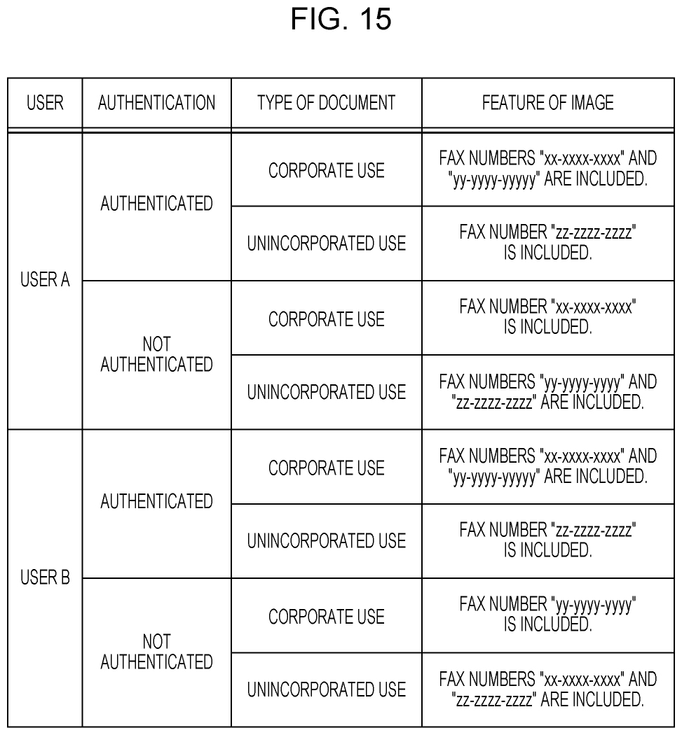

FIG. 15 illustrates an example of the settlement condition of the modification. As in FIG. 14, FIG. 15 illustrates the settlement condition when the image processing service for faxing is used. If the user A uses the image processing service, the same settlement condition as the settlement condition in FIG. 14 is used. Specifically, the settlement condition to be used is that the fee for the image processing service using the fax number “yy-yyyy-yyyy” is a settlement target if the user is authenticated and the fee is not the settlement target if the user is unauthenticated.

If the user B uses the image processing service, the settlement condition to be used is that the fee for the fax to the fax number “xx-xxxx-xxxx” (not to the fax number “yy-yyyy-yyyy”) is the settlement target if the user B is authenticated and the fee is not the settlement target if the user B is not authenticated. The determination is made as described above. If the usage image satisfies the settlement condition that is different from the image processing service in the authenticated case to the image processing service in the unauthenticated case and that is also different from authenticated user to authenticated user, the receipt information output unit 104 outputs the usage information outputs the receipt information as the settlement information to be used in settling the fee for the image processing service.

The settlement condition in FIG. 15 may be applicable as described below. Since the fax number “xx-xxxx-xxxx” is a fax number of a client who the user A is responsible for, it is less likely that the user A uses it for purposes other than the corporate use. Since the fax number “yy-yyyy-yyyy” is the fax number of a client who the user A is not directly responsible for, it is still possible that the user A uses it for personal purpose. Since the fax number “yy-yyyy-yyyy” is the fax number of the client who the user B is responsible for, it is less likely that the user B uses it for purposes other than the corporate use. Since the fax number “xx-xxxx-xxxx” is the fax number of the client who the user B is not directly responsible for, it is still possible that the user B uses it for personal purpose. In accordance with the modification, the accuracy level of the determination as to whether the fee is a settlement target is increased in comparison with the case in which the settlement condition is fixed regardless of whether the authentication has been completed or not.

The settlement destination (a group or organization responsible for expenses) that settles advance amounts is not limited to a corporation but any organization that performs economic activity. Each division in an organization of a user or each project of the organization may have their own budget for settlement. In such a case, the settlement destination may be different depending on the user and/or depending on a job that uses the image processing service.

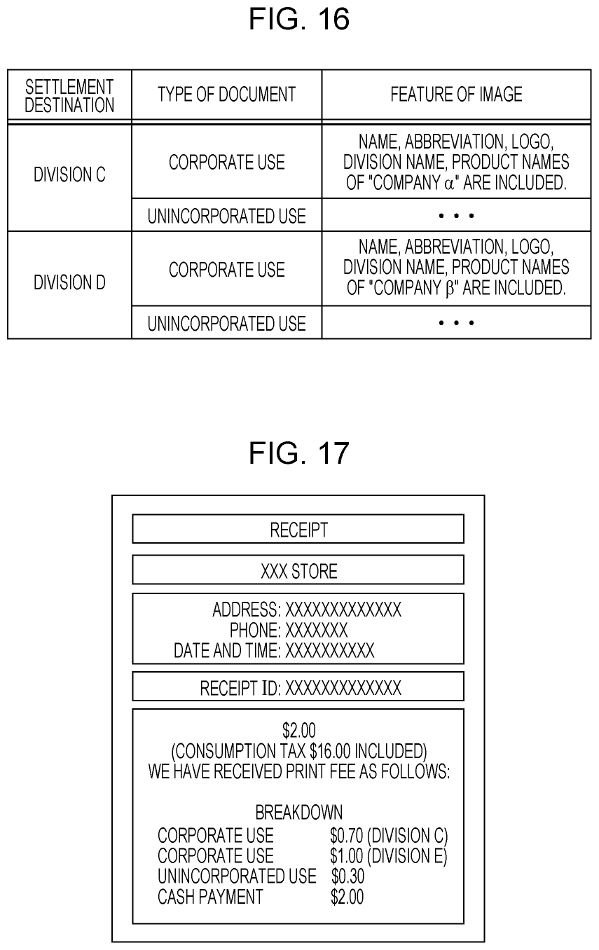

If multiple settlement destinations are present in this way, the settlement condition may be determined on each settlement destination of the fee for the image processing service. FIG. 16 illustrates an example of the settlement condition of the modification. Referring to FIG. 16, if the settlement destination is “division C”, the settlement condition to be used is whether the name “company a”, abbreviation, logo, division name, and product names are included. If the settlement destination is “division D”, the settlement condition to be used is whether the name “company β”, abbreviation, logo, division name, and product names are included.

The company a is a client which the division C is responsible for and the company β is a client which the division D is responsible for. Specifically, the settlement condition on each settlement destination is a condition as to whether a feature frequently appearing in a document related to business corresponding to the settlement destination appears in the usage image. In comparison with the case in which the settlement condition is fixed regardless of the settlement destination, the accuracy level of the determination as to whether the fee is a settlement target is increased.

The usage purpose determination unit 102 stores a settlement destination table that associates the user with the settlement destination. When an authenticated user is identified, the usage purpose determination unit 102 determines the usage purpose by using the settlement condition associated with the authenticated user. The settlement condition herein is the settlement condition determined on a per settlement destination basis. The user may operate to specify the settlement destination when using the image processing service. The settlement condition determined on a per settlement destination basis may thus be used.

In accordance with the exemplary embodiment, the receipt information output unit 104 outputs the receipt information as the settlement information for use in settling the fee for the image processing service. The disclosure is not limited to the method. A list of pieces of information used for settlement (such as the date and time of use, fee, and usage purpose) may be output as the settlement information. Any settlement information may be output as the receipt information as long as the related document proves in the settlement job that the advance payment has been actually performed.

If multiple settlement destinations are involved, the receipt information output unit 104 may output, as the settlement information, information including identification information identifying the settlement destinations. For example, if the settlement destination is a particular division, the identification information identifying the settlement destinations may be the name of the division name or the division code. If the settlement destination is a particular project, the identification information is the name of the project or the project code.

In accordance with the exemplary embodiment, the settlement condition is determined on each settlement destination of the fee for the image processing service as illustrated in FIG. 16. If a usage image satisfies any of the settlement conditions, the receipt information output unit 104 generates as the settlement information the receipt information that associates the fee for the image processing service having used the usage image with the identification information of the settlement destination with the satisfied settlement condition. The receipt information output unit 104 then outputs the settlement information.

FIG. 17 illustrates an example of the receipt information of the modification. Referring to FIG. 17, the breakdown (the usage purpose and fee for each usage image) lists side by side a fee “$0.70” for the corporate use and a “division C” serving as the settlement destination and lists side by side a fee “$1.00” for the corporate use and a “division E” as the settlement destination. The receipt information indicating the fees and the settlement destinations in association with each other is thus output. The user thus performs the settlement job without making a mistake about the settlement destination.

Different settlement conditions may be concurrently satisfied depending on the feature of the usage image. In such a case, the receipt information output unit 104 generates as the settlement information the receipt information indicating the identification information (such as division names) of multiple settlement destinations respectively defining multiple satisfied settlement conditions. The receipt information output unit 104 then outputs the receipt information. In such a case, the user may simply select a more appropriate settlement destination from the multiple division names indicated by the receipt information and performs the settlement process. In this case, as well, the user less likely makes a mistake about the settlement destination by the degree that the settlement destinations are narrowed than when the settlement information does not display the identification information of the settlement destinations.

In accordance with the exemplary embodiment, the advance payment information output unit 105 outputs the advance payment information to the business terminal 30 which has requested the advance payment information. The method of determining the output destination of the advance payment information is not limited to the method described above. For example, as described with reference to the modification, the settlement condition is determined on each settlement destination of the fee for the image processing service as illustrated in FIG. 16.

Multiple settlement destinations may be respectively handled by multiple persons in charge of settlement job and each person in charge may use his or her own business terminal 30. The server apparatus 10 stores a destination table that associates a settlement destination with a destination to a person in charge of the settlement job at the settlement destination. The destination to the person in charge may be an email address of the person or an Internet protocol (IP) address of the business terminal 30 that the person in charge uses.

The settlement destination and the destination may be associated with each other on a one-to-one basis or on a one-to-N basis (N is a natural number) or on an N-to-one basis. If there is a usage image that satisfies one of the settlement conditions, the advance payment information output unit 105 outputs the advance payment information to the destination to the settlement destination having the satisfied settlement condition. The advance payment information output unit 105 is an example of an output unit.

The receipt information is the settlement information that the user uses to settle the fee while the advance payment information is the settlement information that the person in charge of the settlement job uses to settle the fee. For example, the settlement conditions are respectively determined for divisions C, D, and E and are respectively associated with the destinations to persons c, d, and e in charge of the settlement jobs. In such a case, if the settlement condition specified for the division C is satisfied, the advance payment information output unit 105 outputs the advance payment information to the destination to the person c.

If the settlement condition specified for the division D is satisfied, the advance payment information output unit 105 outputs the advance payment information to the destination to the person d. If the settlement condition specified for the division E is satisfied, the advance payment information output unit 105 outputs the advance payment information to the destination to the person e. Since in accordance with the modification, the advance payment information is output to the destination responsive to the settlement condition satisfied by the usage image, the settlement information is transmitted to the settlement destination in advance before the business terminal 30 requests the advance payment information.

The advance payment information to be output to the destination to the person in charge may include information that is disclosed to the division to which the user having used the image processing service belongs and to some employees of a related division. However, the advance payment information is not to be disclosed to employees even in the same company. The information not to be disclosed is an asking price for clients included in the usage image, terms and conditions of a contract, in-house information about clients.

If the usage image that is image-processed in the image processing service includes a portion satisfying a hide condition, the advance payment information output unit 105 may output the image with that portion hidden. The hide condition is satisfied by the information not to be disclosed. In other words, the hide condition is the condition that is satisfied by the information that is prohibited from being displayed in the advance payment information (namely, that is to be hidden).

The advance payment information output unit 105 stores the feature of the image representing the information to be hidden and identifies a portion representing the feature in the usage image. For example, the advance payment information output unit 105 identifies a portion of an image having the feature. The image may be an image representing an amount (such as $), image representing a phone number, an image representing an address (including a map indicating the address), or an image representing words typically used in contracts (such as “agreement” or “signature”).

The advance payment information output unit 105 performs an operation to hide an identified portion of the usage image (hereinafter referred to as a “hide operation”). For example, the hide operation hides a portion of an image by overlaying a black rectangular shape on that portion. Alternatively, the hide operation may delete a page including the identified portion or gray out the identified portion. The advance payment information output unit 105 outputs the advance payment information including the usage image having undergone the hide operation. In this way, the information not to be disclosed even to a person in charge of the settlement job remains undisclosed to the person.

The settlement process performed by a person in charge of the settlement job (office work performed by a person) may be performed by a settlement system. The settlement system performs a digital process related to payment to the user who has done the advance payment (such as an operation to transfer the corresponding amount to the account of the user). In such a case, the person in charge inputs, to the settlement system, information (advance amount, employee ID, and the like) used to pay the advance amount.

In accordance with the modification, the advance payment information output unit 105 directly outputs the advance payment information to the settlement system. The employee who has paid the advance amount is to be identified in the settlement. In accordance with the modification, the authenticated is thus performed and the image processing service is used with the user identified. The advance payment information output unit 105 outputs to the settlement system the advance payment information including the advance amount and information (such as employee ID) identifying the person who has been authenticated.

The settlement system performs a transfer operation to transfer the advance amount to the user using the output advance payment information. Such time for a manual entry operation performed by the person in charge is less than when the advance payment information is not output to the settlement system. In accordance with the modification, the advance payment information output unit 105 may output the advance payment information to a destination to the person in charge of the settlement job. If only the usage fee for the corporate use is included in the relevant information, the server apparatus 10 outputs the advance payment information to only the settlement system.

The usage fee for the corporate use and the usage fee with the purpose unknown are included in the relevant information. Whether to settle the usage fee with the purpose unknown is not clear and thus the server apparatus 10 outputs the advance payment information to both the settlement system and the destination to the person in charge of the settlement job. In such a case, the advance payment information output unit 105 outputs the advance payment information that is different in content from the settlement system to the destination to the person in charge.

Specifically, the advance payment information output unit 105 outputs to the settlement system the advance payment information including a minimum amount of information related to the settlement process of the advance amount. The advance payment information output unit 105 also outputs, to the destination to the person in charge, the advance payment information including information that is used for the person in charge to determine whether the contents of the usage image with the purpose unknown are viable to be settled. For example, the information for the determination may be the date and time of use, location of use, document name, and/or usage image.

The advance payment information output unit 105 outputs to the settlement system the advance payment information not including a usage image not larger in data amount while outputting to the destination to the person in charge the advance payment information that is useful in the determination of the usage purpose. In this way, a smaller communication load with the settlement system results than when the advance payment information normally including the usage image is output. The person in charge of the settlement job more easily determines the usage fee than when the advance payment information not normally including the usage image is output.

A determination as to whether to include in the settlement information, information on an image not satisfying the settlement condition, in other words, information on an image processed in the image processing service used for the personal purpose (for example, expenses outside the settlement target) may be set to be different depending on the output destination of the settlement information. In accordance with the modification, there are two output destinations of the settlement information.

A first destination is an apparatus that receives information on the payment to a service provider of image processing. For example, the first destination is the image processing apparatus 20. The information on the payment may indicate the name of a store, address of the store, phone number of the store, date and time of use, receipt ID, and usage fee included in the receipt. The receipt information output unit 104 outputs to the image processing apparatus 20 the receipt information described with reference to the exemplary embodiment as the settlement information including the information on the image not satisfying the settlement condition.

A second destination is the destination to the person in charge of the settlement job described above. The advance payment information output unit 105 outputs to the destination the settlement information not including information on the image not satisfying the settlement condition. For example, the information on the image not satisfying the settlement condition is a fee for the unincorporated use illustrated in FIG. 11. The fee with purpose unknown is not clear as to whether the corresponding image satisfies the settlement condition or not. The fee with purpose unknown may or may not be included in the information on the image not satisfying the settlement condition.

In accordance with the modification, the receipt information output unit 104 and advance payment information output unit 105 operate in concert with each other as an example of the “output unit” of the disclosure. Since the settlement information including the information on the image not satisfying the settlement condition is output to the first destination, the user of the image processing service may verify the fee that is not the settlement target. Since the settlement information not including the information on the image not satisfying the settlement condition is output to the second destination, an amount of information that the person in charge of the settlement job is to verify is smaller than when the information on the image not satisfying the settlement condition is normally included.

The apparatus implementing the functions in FIG. 5 is not limited to those illustrated in the drawings. For example, the functions implemented by the server apparatus 10 may be implemented by two or more information processing apparatuses or a computer resource provided by a cloud service. The usage purpose determination unit 102 performs two determination operations, one for the corporate use and the other for the unincorporated use. The two determination operations may be separately carried out by two different functions. The operations performed by the receipt information output unit 104 and the advance payment information output unit 105 may be carried out by a single function that outputs the receipt information and the advance payment information as the settlement information. As long as the functions in FIG. 5 are implemented by the entire image reading system, the function sharing of the apparatuses and the range of the operation of each function of each apparatus may be freely decided.

In the exemplary embodiments above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The disclosure is related to the information processing apparatuses including the server apparatus, image processing apparatus, and business terminal. The disclosure is also related to an information processing system including the information processing apparatus. The disclosure is also related to an information processing method that performs the process of each information processing apparatus or a program causing a computer to control the information processing apparatus. The program may be supplied in a recorded form on a recording medium, such as an optical disk. The program may also be supplied by downloading and installing it onto the computer via a communication network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus, comprising:
an acquisition unit that acquires an image used in paid image processing; and
an output unit that outputs settlement information for use in settlement of a fee for the image processing if the image satisfies a settlement condition indicating whether the fee is a settlement target.

2. The information processing apparatus according to claim 1, wherein the settlement condition is determined on each settlement destination of the fee.

3. The information processing apparatus according to claim 2, wherein the output unit outputs the settlement information including identification information identifying the settlement destination.

4. The information processing apparatus according to claim 2, wherein the output unit outputs the settlement information to a destination corresponding to the settlement destination specified in the satisfied settlement condition.

5. The information processing apparatus according to

3. , wherein the output unit outputs the settlement information to a destination corresponding to the settlement destination specified in the satisfied settlement condition.

6. The information processing apparatus according to claim 1, further comprising an authenticating unit that authenticates a user of the image processing,
wherein the output unit outputs the settlement information if the image satisfies the settlement condition that is different from the image processing with the user authenticated to the image processing with the user unauthenticated.

7. The information processing apparatus according to claim 2, further comprising an authenticating unit that authenticates a user of the image processing,
wherein the output unit outputs the settlement information if the image satisfies the settlement condition that is different from the image processing with the user authenticated to the image processing with the user unauthenticated.

8. The information processing apparatus according to claim 3, further comprising an authenticating unit that authenticates a user of the image processing,
wherein the output unit outputs the settlement information if the image satisfies the settlement condition that is different from the image processing with the user authenticated to the image processing with the user unauthenticated.

9. The information processing apparatus according to claim 4, further comprising an authenticating unit that authenticates a user of the image processing,
wherein the output unit outputs the settlement information if the image satisfies the settlement condition that is different from the image processing with the user authenticated to the image processing with the user unauthenticated.

10. The information processing apparatus according to claim 5, further comprising an authenticating unit that authenticates a user of the image processing,
wherein the output unit outputs the settlement information if the image satisfies the settlement condition that is different from the image processing with the user authenticated to the image processing with the user unauthenticated.

11. The information processing apparatus according to claim 6. , wherein the output unit outputs the settlement information if the image satisfies the settlement condition that is different according to the authenticated user.

12. The information processing apparatus according to claim 7, wherein the output unit outputs the settlement information if the image satisfies the settlement condition that is different according to the authenticated user.

13. The information processing apparatus according to claim 8, wherein the output unit outputs the settlement information if the image satisfies the settlement condition that is different according to the authenticated user.

14. The information processing apparatus according to claim 9, wherein the output unit outputs the settlement information if the image satisfies the settlement condition that is different according to the authenticated user.

15. The information processing apparatus according to claim 1, wherein the output unit outputs, to a destination to a person in charge of a settlement job of the fee, the settlement information including an image that has undergone the image processing.

16. The information processing apparatus according to claim 2, wherein the output unit outputs, to a destination to a person in charge of a settlement job of the fee, the settlement information including an image that has undergone the image processing.

17. The information processing apparatus according to claim 15, wherein if the image having undergone the image processing includes a portion satisfying a hide condition, the output unit outputs the settlement information including an image with the portion hidden.

18. The information processing apparatus according to claim 1, wherein the output unit outputs, to a system performing an operation related to the settlement and a destination corresponding to a person in charge of a settlement job of the fee, the settlement information having contents that are different from the system to the destination.

19. The information processing apparatus according to claim 18, wherein the output unit outputs the settlement information not including the image to the system and the settlement information including the image to the destination.

20. The information processing apparatus according to claim 1, wherein the output unit outputs, to a device that outputs information related to payment to a provider of the image processing, the settlement information including information on an image that does not satisfy the settlement condition and, to a destination corresponding to a person in charge of a settlement job of the fee, the settlement information not including the information on the image that does not satisfy the settlement condition.
